(19) United States
(12) Patent Application Publication
(10) Pub. No.: US 2002/0100801 A1
(43) Pub. Date: Aug. 1, 2002

(54) Method for automotive vehicle refueling and transactions therefor using a microchip card

(76) Inventor: Phanthong Na-Ranong, Bangkok (TH)

Correspondence Address: Edward Gray, P.O. Box 66629, Mar Vista, CA, 90066-0629, US

(21) Appl. No.: 09/775,426

(22) Filed: Feb. 1, 2001

(51) Int. Cl. G06F 7/08

(52) U.S. Cl. 235/381

(57) ABSTRACT

A method for refueling an automotive vehicle at a service station wherein a customer-carried card used to pay for the fuel does not have to be verified for credit status or used to debit a customer's bank account by a computer remote from the station. The method includes the sequential steps of: (a) prerecording customer data onto a card microchip memory; (b) inserting the card into a reader/writer portion of a device attached to a fuel pump which verifies the data; (c) inputting customer-specified refueling transaction data using a keypad attached to the reader/writer; (d) processing the inputted data and commanding refueling by a radio-control and data processing unit; (e) recording updated transaction data onto the microchip memory; and (f) recording the updated data onto a station memory unit and subsequently reporting the data to the card issuer.

### BACKGROUND OF THE INVENTION

1. Field Of The Invention

The invention relates to automotive fuel dispensing systems with automated transaction processing, and more particularly to systems in which a customer-carried card inserted into a card reader initiates and indirectly controls refueling and associated customer identification, authorization and payment transactions.

2. Description Of The Related Art

In refueling cars and trucks at service stations worldwide, payment is most often made in cash. Payment using a credit card is often troublesome and time-consuming because the customer must wait until his card is remotely verified for authenticity and credit limit status. In the best of circumstances this process takes several minutes. But if the issuing bank or other financial institution cannot be queried because its central computer is down or the telephone connection is busy, the card cannot be approved and the customer must then choose between the often inconvenient options of paying cash or foregoing refueling.

Fully automated self-service fuel dispensing systems have been developed in which a credit card or specially prepared card document is inserted into a card reader. Selected data on the card are then either locally or remotely processed by a computer for verification of the card-holder's identity and enablement of various transactions. Such automated systems may be operated either “off-line,” i.e., a central computer is not involved in the refueling process, or “on-line” in conjunction with a centrally located on-line computer which nmy or may not be collocated with the service station.

Systems which use a customer-carried card to initiate and control fueling and related transactions are disclosed in U.S. Pat. No. 3,931,497 to F. J. Gentile et al., U.S. Pat. No. 4,085,313 to B. O. Van Ness, and U.S. Pat. No. 5,859,416 to J. G. Gatto.

### SUMMARY OF THE INVENTION

The invention provides a method for refueling an automotive vehicle and executing transactions therefor. The method includes a first step of prerecording customer-related data onto a microchip having a readable/writeable memory which is an integral portion of a card subsequently issued by an issuer to a predetermined customer. The method further includes a second step of inserting the card into a reader/writer portion of a device attached to a fuel pump located at a service station which reads the data stored in the microchip memory. The device also includes a keypad portion and a monitor portion both in electrical communication with the reader/writer portion, and a transceiver in two-way communication with a combined radio-control and data processing unit on-site at the station. The method also includes specifying the quantity and grade of fuel to be pumped from a preselected pump nozzle attached to a nozzle controller by entering data using the keypad portion imto the reader/writer portion, and then transmitting the data to the radio-control and data processing unit. The method also includes processing the transmitted data at the radio-control and data processing unit, and then transmitting a command signal from the unit to a central pump controller in electrical communication with the nozzle controller. The pump controller then transmits a signal to the nozzle controller to provide fuel in the specified quantity. The method also includes transmitting a signal from the radio-control and data processing unit to the device reader/writer portion to command recording of data describing the refueling incident onto the microchip memory. The method further includes recording the data describing the refueling incident onto a memory unit at the service station.

A more complete understanding of the present invention and other objects, aspects and advantages thereof will be gained from a consideration of the following description of the preferred embodiment read in conjunction with the accompanying drawing provided herein. In the figure and description, numerals indicate the various features of the invention, like numerals referring to like features throughout both the drawing and description.

### BRIEF DESCRIPTION OF THE DRAWING

FIGURE 1 is a schematic illustration of the sequence of method steps according to the invention.

### DESCRIPTION OF THE PREFERRED EMBODIMENT

While the present invention is open to various modifications and alternative constructions, the preferred embodiment shown schematically in the drawing will be described herein in detail. It is to be understood, however, there is no intention to limit the invention to the particular form disclosed. On the contrary, it is intended that the invention cover all modifications, equivalences and alternative constructions falling within the spirit and scope of the invention as expressed in the appended claims.

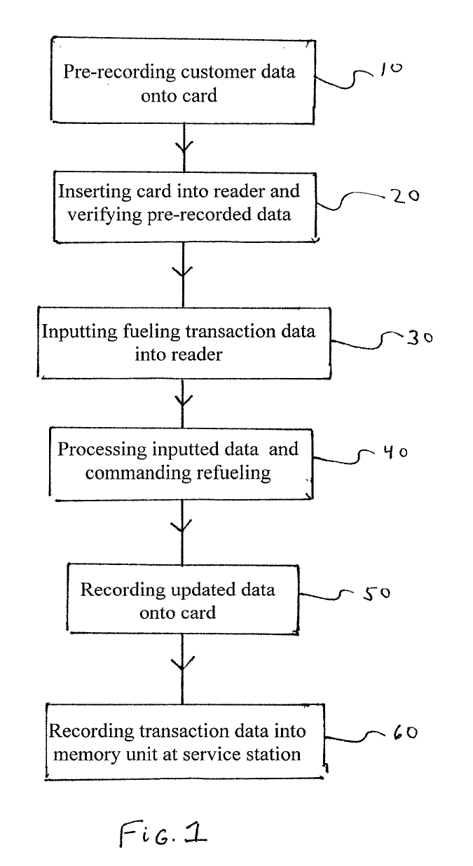

Referring to FIGURE 1, a method for automated refueling of an automotive vehicle and executing transactions therefor according to the invention includes a first step 10 wherein a card to be issued to a customer who has previously made application to an issuer for the card and provided required personal data is prerecorded with the data by the issuer, typically a financial institution or the financial division of an oil corporation. Such data include a card identification code, the customer's name and address, and a customer identification number. The data are entered digitally onto a microchip having a readable/writeable memory which is an integral portion of the card, together with coded sets of instructions for performing operations at service stations which the card will enable and, optionally, ancillary data such as a customer password and sales-promotion data such as price discounts or rebates for selected automotive fuel products. Also entered into the microchip memory is the value of an initial amount of money which the customer has prepaid to the issuer, from which the cost of each future refueling incident will be sequentially deducted. Preferably, all data entered onto the microchip are securely protected. Access to the microchip requires authentication using a set of keys before being able to command reading/writing. Unlike a debit card wherein the available balance in a customer's bank account must be verified before the card can be used, the card of the present invention guarantees payment up to the value currently stored in the microchip. The card issuer selects the amount of memory to be used in the microchip according to the amount of data required to be stored.

Still referring to FIGURE 1, the method further includes a second step 20 wherein the customer after arriving at a service station has her card inserted into a card reader/writer portion of a device which also includes a keypad portion and a monitor portion. Preferably, the keypad portion has a “PINPAD” and the monitor portion has a liquid crystal display (LCD). The device further includes a transceiver in two-way wireless communication with a combined radio-control and data processing unit located in the station office. Preferably, at a self-service station the device is permanently attached to a gas pump so that the customer can insert the card. Alternatively, a portable version of the device is carried by a station attendant to whom the customer presents the card for insertion. The device reader/writer portion, which is provided with a set of authentication keys, attempts to unlock and read the data stored in the microchip of the inserted card. The customer may be required to key-in an alphanumeric password which the device reader/writer portion in its reader mode will compare with the password stored in the microchip. If decryption and readout are successful, the card is authenticated and the read-out data are verified.

Referring again to FIGURE 1, the method further includes a third step 30 wherein the customer or service attendant using the device keypad portion specifies the desired grade of fuel and the number of a pump dispensing such fuel whose nozzle is accessible to the vehicle's fuel tank, as well as the number of gallons or liters of fuel desired or, alternatively, a preselected amount of money to be spent. Attached to the pump nozzle is a nozzle controller activated by a central pump controller in electrical communication with the nozzle controller via a dedicated hard-wired signal line. Each pump nozzle controller is connected to the central pump controller by a similar dedicated line. The central pump controller, which controls all nozzle controllers, is in electrical communication with the radio-control and data processing unit.

Referring again to FIGURE 1, the method further includes a fourth step 40 wherein the data inputted using the device keypad portion are processed and a fuel-flow command is issued to the nozzle controller. When the customer specifies a fixed sum of money, the device calculates the corresponding quantity of fuel using the formula: Quantity=Sum divided by the price of fuel per gallon or liter. If the customer specifies the number of gallons or liters, the device calculates the corresponding sum to be paid using the formula: Sum=Quantity multiplied by the price of fuel per gallon or liter. Fuel prices for the several grades available are available from a rate table stored in the device reader/writer portion. In the event the fuel actually pumped is less than what was specified by the customer or the customer is entitled to a discount or rebate, the device reader/writer portion inputs a value into the microchip memory for the credited amount. Such remunerated sums are calculated by the device according to the formula: Sum=Quantity multiplied by remuneration rate per gallon or liter. Before refueling can begin, the net balance in the card is calculated by the device according to the formula: Sum (after refueling)=Sum (before refueling)−Sum (purchase)+Sum (remuneration). The device monitor portion then displays the several sums for visual confirmation. When the customer or the service attendant presses a confirmation key on the device, a wireless signal is transmitted from the device to the radio-control and data processing unit which then issues instruction sets to the central pump controller. The pump controller then transmits a command via the dedicated signal line to the nozzle controller to refuel the vehicle with the quantity of fuel specified by the customer.

Referring again to FIGURE 1, the method further includes a fifth step 50 wherein data describing the just completed refueling incident are recorded onto the card microchip memory. Updated data include the grade of fuel pumped, the number of gallons or liters, the fuel unit price, price discount or rebate (if applicable), and the net balance now available for future purchases. The radio-control and data processing unti transmits a set of instructions to the device reader/writer portion to input the appropriate updated data onto the card microchip. The card is then automatically ejected from the reader/writer portion to be retrieved by the customer. The customer can opt to increase the card value by entering the station office and having the card inserted into a card reader/writer device which can access the customer's bank account in debit mode,

Referring again to FIGURE 1, the method further includes a sixth step 60 wherein data describing the refueling incident are permanently recorded onto a memory unit at the service station and subsequently forwarded to the card issuer, preferably via a cryptographically secure telephone line.

What is claimed is:

1. A method for refueling an automotive vehicle and executing transactions therefor comprising the steps of:
prerecording customer-related data onto a microchip having a readable/writeable memory, the microchip being an integral portion of a card subsequently issued by an issuer to a predetermined customer;
inserting the card into a reader/writer portion of a device attached to a fuel pump located at a service station, the pump having a nozzle attached to a nozzle controller, said reader/writer portion reading the data stored in the microchip memory, said device further comprising a keypad portion and a monitor portion in electrical communication with the reader/writer portion, and a transceiver in two-way communication with a combined radio-control and data processing unit disposed at a preselected location within the station;
specifying the quantity and grade of fuel to be pumped from said preselected pump by using the device keypad portion to enter data into the reader/writer portion, and transmitting said data from said device to the radio-control and data processing unit;
processing said transmitted data at the radio-control and data processing unit, said unit transmitting a command signal to a central pump controller in electrical communication with said nozzle controller, the pump controller transmitting a signal to the nozzle controller to provide fuel in the specified quantity; and
transmitting a signal from the radio-control and data processing unit to the device reader/writer portion commanding recording of data describing the refueling incident onto said microchip memory.

2. The method of claim 1 further comprising recording said data describing the refueling incident onto a memory unit disposed within the service station.

3. The method of claim 1 wherein electrical communication between the device transceiver and the radio-control and data processing unit is wireless.

4. The method of claim 1 wherein electrical communication between the central pump controller and the nozzle controller is through a hard-wired circuit.
